(19) United States
(12) Patent Application Publication
(10) Pub. No.: US 2006/0041853 A1
(43) Pub. Date: Feb. 23, 2006

(54) CAD apparatus, symbol creation device, CAD program storage medium and symbol creation program storage medium

(75) Inventors: Kenji Kawasaki, Kawasaki (JP); Tsuneo Oka, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/995,322

(22) Filed: Nov. 24, 2004

(30) Foreign Application Priority Data
Aug. 19, 2004 (JP) 2004-239725

(51) Int. Cl. G06F 17/50

(52) U.S. Cl. 716/11; 716/10

(57) ABSTRACT

The present invention provides a CAD apparatus having high plotting efficiency, a symbol creation device facilitating symbol creation, a CAD program storage medium storing a CAD program incorporated into a computer to enable the computer to operate as the CAD apparatus, and a symbol creation program storage medium storing a symbol creation program incorporated into a computer to enable the computer to operate as the symbol creation device. There are provided a symbol data reading section that acquires table data (symbol data) representing a list describing attributes of each pin of an electronic part having plural pins, and a symbol creation section that applies each symbol pin having the same attribute as each attribute described in the list represented by table data acquired by the table data acquirement section to a part symbol representing the electronic part in arrangements corresponding to a described position of the attribute in the list.

### BACKGROUND OF THE INVENTION

1. Field of the Invention

The present invention relates to a CAD apparatus that creates the drawing in accordance with an operation, a symbol creation device that creates a symbol for use with the CAD apparatus, a CAD program for enabling a computer to operate as the CAD apparatus, and a symbol creation program for enabling a computer to operate as the symbol creation device.

2. Description of the Related Art

Conventionally, a graphic output apparatus that is called a CAD (Computer-Aided Design) apparatus has been employed in various fields, for example, an electric circuit design field, an electric power system management field (e.g., refer to Published Unexamined Patent Application No. 2003-208340), and an architecture field (e.g., refer to Published Unexamined Patent Application No. 2002-15271). The common plotting operation with the CAD apparatus involves arranging lines, components, or symbols on the screen, employing a mouse or a keyboard.

Also, a proposal for simplifying the plotting operation using the CAD apparatus is well known (e.g., refer to Published Unexamined Patent Application No. 2002-230052 and Published Unexamined Patent Application No. 10-149375). In these documents, the CAD apparatuses for inputting data describing the coordinates on the drawing and arranging the line and component on the drawing as described were proposed.

By the way, along with the technological development of LSIs, the circuit has been miniaturized using a so-called chip component, especially in the electronic circuit design field. The chip component is an aggregate of large-scale circuits, and in making the circuit design with the chip components, the structure of an internal circuit of the chip component is treated as a black box and the signal input and output for the chip component are designed. Thereby, the design labor is reduced.

The symbol representing the chip component in the circuit design is registered in the CAD apparatus, and drawn on the circuit diagram. The chip component has many pins useful for the signal input and output, and the attributes of the kind of signal and the input and output form must be defined for each of many pins on the symbol. In the conventional CAD apparatus, the size of symbol is changeable from the specimen of symbol, the attribute of each pin is undefined, the selection of pin with the mouse operation, and the input of attributes with the keyboard operation and mouse operation are repeated for each pin, so that the symbol actually drawn on the circuit diagram is created.

However, in recent years, there are increasingly a greater number of pins as many as several hundreds to thousands pins, whereby the creation of symbol through the above-described operation is very intricate, degrading a plotting efficiency. Generally, since the drawing position of wiring on the circuit diagram and the wiring site on the actual circuit are different, the pin position on the symbol and the pin position on the actual chip component are often different, whereby one chip component is often divided into plural symbols for representation to secure a drawing space for wiring on the circuit diagram. Therefore, when a different circuit design is made employing the same chip component, it is necessary that the symbol is newly defined according to the preference of the designer, further degrading the plotting operation efficiency.

### SUMMARY OF THE INVENTION

The present invention has been made in view of the above circumstances and provides a CAD apparatus having high operation efficiency, a symbol creation device capable of easy creation of symbol, a CAD program incorporated into a computer to enable the computer to operate as the CAD apparatus, and a symbol creation program incorporated into the computer to enable the computer to operate as the symbol creation device.

The present invention provides a CAD apparatus having a plotting function of creating a drawing by arranging a part symbol at a position according to an operation, and a symbol creation function of creating the part symbol, including a table data acquirement section that acquires table data representing a list describing the attributes of each pin of an electronic part having plural pins, and a symbol pin arrangement section that applies each symbol pin having the same attribute as each attribute described in the list represented by table data acquired by the table data acquirement section to a part symbol representing the electronic part in an arrangement corresponding to a described position of the attribute in the list.

With the CAD apparatus of the invention, the user of the CAD apparatus can define the attributes of each pin in the list, and decide the final position of symbol pin only by describing the attributes on the list. Accordingly, there is less trouble of repeating the selection of pin and the input of attribute, improving the operation efficiency. Since the position of symbol pin on the part symbol is usually disposed at regular interval, the CAD apparatus decides the pin arrangement on the symbol from the described position on the list, using a simple conversion algorithm.

Also, the user can easily create this list using an accustomed spread sheet software, whereby the operation efficiency is further improved.

In the CAD apparatus of the invention, it is preferable that the symbol pin arrangement section treats a blank column in the list as a position where the symbol pin does not exist.

On the part symbol, the symbol pins are often grouped and described with a clearance to enhance the visibility in the circuit diagram. With the preferred CAD apparatus as described above, the clearance for grouping is easily defined by providing a blank column in the list.

Also, the invention provides a symbol creation device that creates a part symbol to be used with a CAD apparatus that creates a drawing by arranging a part symbol at a position according to an operation, including: a table data acquirement section that acquires table data representing a list describing the attributes of each pin of an electronic part having plural pins, and a symbol pin arrangement section that applies each symbol pin having the same attribute as each attribute described in the list represented by the table data acquired by the table data acquirement section to a part symbol representing the electronic part in an arrangement corresponding to a described position of the attribute in the list.

With the symbol creation device of the invention, like the CAD apparatus of the invention, the part symbol is based on the list, and easily created.

Also, the invention provides a CAD program storage medium storing a CAD program incorporated into a computer to enable the computer to operate as a CAD apparatus having a plotting function of creating a drawing by arranging a part symbol at a position according to an operation, and a symbol creation function of creating the part symbol, the program constructing on the computer including: a table data acquirement section that acquires table data representing a list describing the attributes of each pin of an electronic part having plural pins; and a symbol pin arrangement section that applies each symbol pin having the same attribute as each attribute described in the list represented by the table data acquired by the table data acquirement section to a part symbol representing the electronic part in an arrangement corresponding to a described position of the attribute in the list.

With the CAD program of the invention, the CAD apparatus of the invention is easily realized using the computer.

Also, the invention provides a symbol creation program storage medium storing a symbol creation program incorporated into a computer to enable the computer to operate as a symbol creation device that creates a part symbol to be used with a CAD apparatus that creates a drawing by arranging the part symbol at a position according to an operation, the program constructing on the computer including: a table data acquirement section that acquires the table data representing a list describing the attributes of each pin of an electronic part having plural pins, and a symbol pin arrangement section that applies each symbol pin having the same attribute as each attribute described in the list represented by the table data acquired by the table data acquirement section to a part symbol representing the electronic part in an arrangement corresponding to a described position of the attribute in the list.

With the symbol creation program of the invention, the symbol creation device of the invention is easily realized using the computer.

Though the symbol creation device, the CAD program, and the symbol creation program are illustrated here only in their basic forms to simply avoid the duplication, the symbol creation device, the CAD program, and the symbol creation program of the invention may be implemented not only in their basic forms but also in various forms corresponding to the CAD apparatus.

Regarding the elements such as the table data acquirement section constructed on the computer by the CAD program and the symbol creation program of the invention, one element may be implemented by one program component, or plural program components, or plural elements may be implemented by one program component. Also, these elements may be constructed to perform the action by themselves, or constructed by giving an instruction to another program or program component incorporated into the computer.

As described above, the CAD apparatus and the CAD program storage medium of the invention allow for the high plotting efficiency, and the symbol creation device and the symbol creation program storage medium of the invention allow for the easy creation of symbol.

### BRIEF DESCRIPTION OF THE DRAWINGS

FIG. 1 is a view showing a computer system according to one embodiment of the invention;

FIG. 2 is a hardware configuration diagram of a personal computer;

FIG. 3 is a diagram showing a CAD program storage medium according to the embodiment of the invention;

FIG. 4 is a functional block diagram of a CAD apparatus according to the embodiment of the invention;

FIG. 5 is a table showing the configuration of a list representing the symbol data; and

FIG. 6 is a flowchart showing a procedure of the symbol creation module to create the symbol based on the symbol data.

### DETAILED DESCRIPTION OF THE INVENTION

The preferred embodiments of the present invention will be described below with reference to the accompanying drawings.

In the following, according to one embodiment of the invention, a CAD program stored in a CAD program storage medium is incorporated into a personal computer and is executed, so that the computer operates as a CAD apparatus according to the embodiment of the invention. Also, the CAD program storage medium and the CAD apparatus contain a symbol creation program storage medium and a symbol creation device according to the embodiment of the invention.

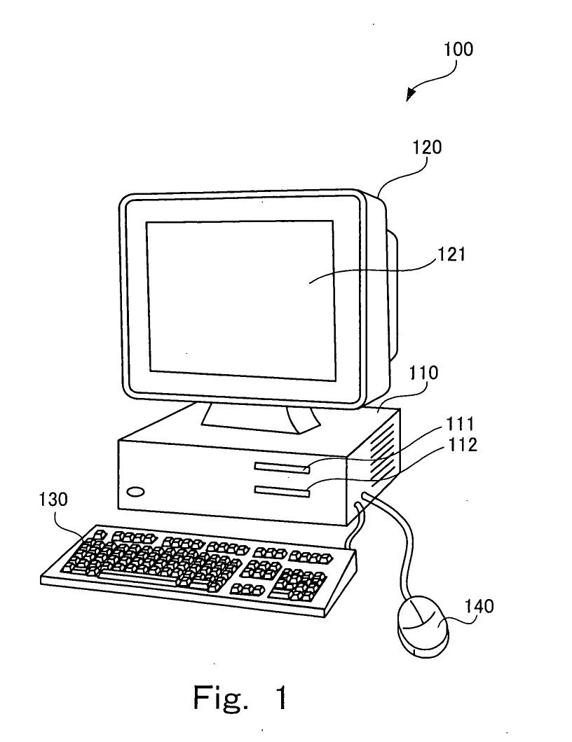

FIG. 1 is a view showing a computer system according to one embodiment of the invention.

In this embodiment, the CAD apparatus and the symbol creation device are realized on a personal computer 100 as described above.

This personal computer 100 comprises a main section 110 containing a CPU, a RAM memory and a hard disk, an image display device 120 that displays the screen on a fluorescent screen 121 upon an instruction from the main section 110, a keyboard 130 that enables the user to input an instruction or character information into the personal computer, and a mouse 140 that is used to designate arbitrary position on the fluorescent screen 121 to input an instruction corresponding to the position.

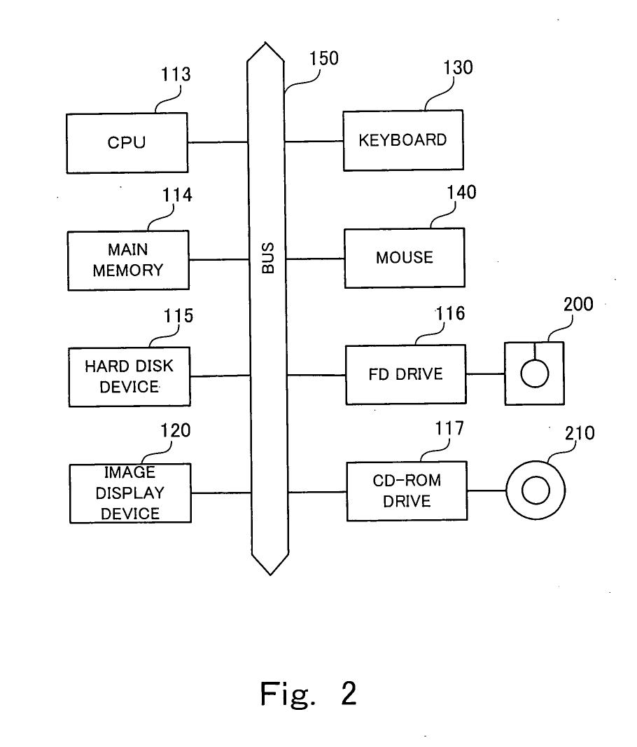

The main section 110 further comprises a flexible disk loading opening 111 and a CD-ROM loading opening 112 through which a flexible disk 200 and a CD-ROM 210 (not shown in FIG. 1, see FIG. 2) are loaded, and internally a flexible disk drive 116 and a CD-ROM drive 117 (see FIG. 2) to drive the loaded flexible disk and the CD-ROM.

FIG. 2 is a hardware configuration diagram of the personal computer.

Herein, a Central Processing Unit (CPU) 113, a main memory 114, a hard disk device 115, the flexible disk drive 116, the CD-ROM drive 117, the mouse 140, the keyboard 130, and the image display device 120 are shown and interconnected via a bus 150.

The flexible disk drive 116 is loaded with a flexible disk 200 and makes access to the loaded flexible disk 200, and the CD-ROM drive 117 is loaded with a CD-ROM 210, and makes access to the CD-ROM 210, as described with FIG. 1.

Herein, when the CD-ROM 210 storing a CAD program according to the embodiment of the invention is loaded through the CD-ROM loading opening 112 into the main section 110, the CAD program is read from the CD-ROM 210 by the CD-ROM drive 117, passed through the bus 150, and stored in the hard disk device 115. If the CAD program stored in this hard disk device 115 is loaded on the main memory 114, and executed by the CPU 113, the personal computer operates as a CAD apparatus according to the embodiment of the invention.

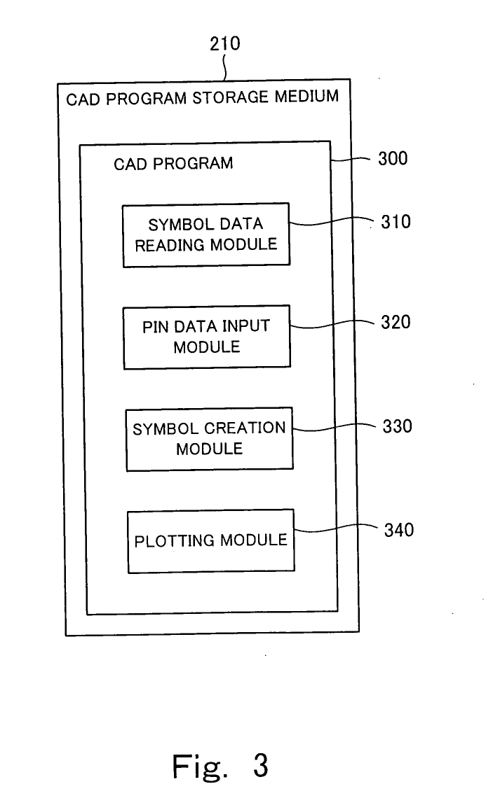

FIG. 3 is a diagram showing a CAD program storage medium according to the embodiment of the invention. Herein, the CAD program 300 is stored in the CD-ROM 210.

The CAD program 300 is executed within the personal computer 100 as shown in FIG. 1, enables the personal computer 100 to operate as a so-called CAD apparatus, and comprises a symbol data reading module 310, a pin data input module 320, a symbol creation module 330 and a plotting module 340. Of these elements, the symbol data reading module 310, the pin data input module 320, and the symbol creation module 330 make up a symbol creation program according to the embodiment of the invention.

The details of each element of the CAD program 300 will be described later.

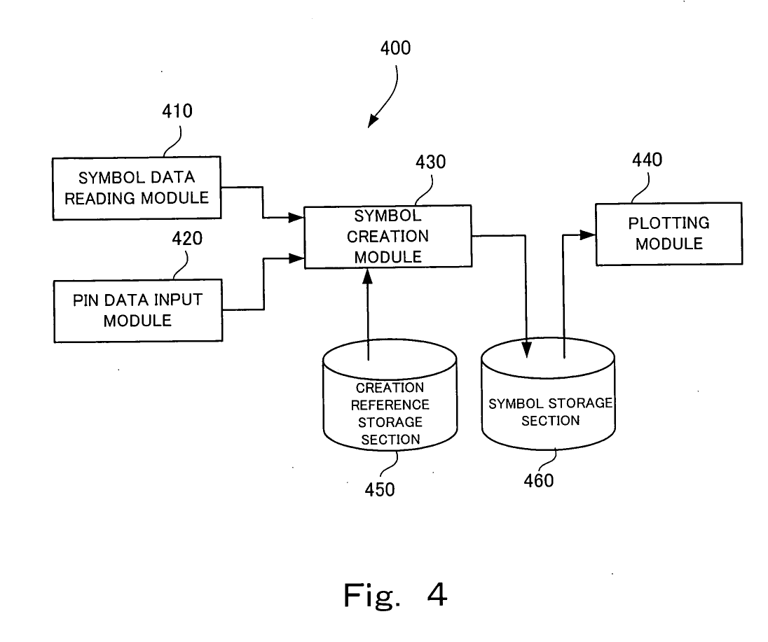

FIG. 4 is a functional block diagram of a CAD apparatus according to the embodiment of the invention.

The CAD apparatus 400 is based on the CAD program 300 of FIG. 3 that is installed and executed in the personal computer 100 as shown in FIG. 1.

The CAD apparatus 400 is composed of a symbol data reading module 410, a pin data input module 420, a symbol creation module 430, a plotting module 440, a creation reference storage section 450, and a symbol storage section 460. Of these elements, the symbol data reading module 410, the pin data input module 420, the symbol creation module 430 and the plotting module 440 are constructed on the personal computer 100 by the symbol data reading module 310, the pin data input module 320, the symbol creation module 330 and the plotting module 340, respectively, making up the CAD program 300 as shown in FIG. 3. In this way, though each element of the CAD apparatus 400 as shown in FIG. 4 corresponds to each element of the CAD program 300 as shown in FIG. 3, a different point is that each element of FIG. 4 is constituted of a combination of the hardware of the personal computer 100 as shown in FIG. 1 and the OS or application program executed on the personal computer, but each element of FIG. 3 is constituted of an application program alone.

The creation reference storage section 450 is constituted by the hard disk device 115, and the symbol storage section 460 is constituted by the main memory 114, as shown in FIG. 2.

Also, of the elements of the CAD apparatus 400, the symbol data reading module 410, the pin data input module 420, the symbol creation module 430 and the creation reference storage section 450 correspond to the symbol creation device according to the embodiment of the invention, and carries a symbol creation function in the CAD apparatus of the invention. Also, the symbol data reading module 410 corresponds to a table data acquirement section and the symbol creation module 430 corresponds to a symbol pin arrangement section in the invention.

Each element of the CAD apparatus 400 as shown in FIG. 4 will be outlined below.

The symbol data reading module 410 constituting the CAD apparatus 400 of FIG. 4 reads the symbol data defining the attribute of each pin of the symbol denoting an electronic part in the format of a list. In this embodiment, such symbol data is created in advance by the user of the CAD apparatus 400, employing a spread sheet software and the like. On the other hand, the pin data input module 420 inputs the pin attribute for each pin through a mouse operation or keyboard operation in the same way as conventionally.

The symbol creation module 430 receives the symbol data or attribute from the symbol data reading module 410 and the pin data input module 420, creates the symbol, employing the creation criteria stored in the creation reference storage section 450, and stores the symbol in the symbol storage section 460.

The plotting module 440 performs a plotting process based on a mouse operation or keyboard operation in the same way as conventionally, the symbols stored in the symbol storage section 460 are appropriately read and employed for plotting.

The CAD apparatus 400 of this embodiment is basically constituted in the above way. Herein, the configuration of a list representing the symbol data and a procedure of the symbol creation module 430 to create the symbol according to the symbol data will be described in detail.

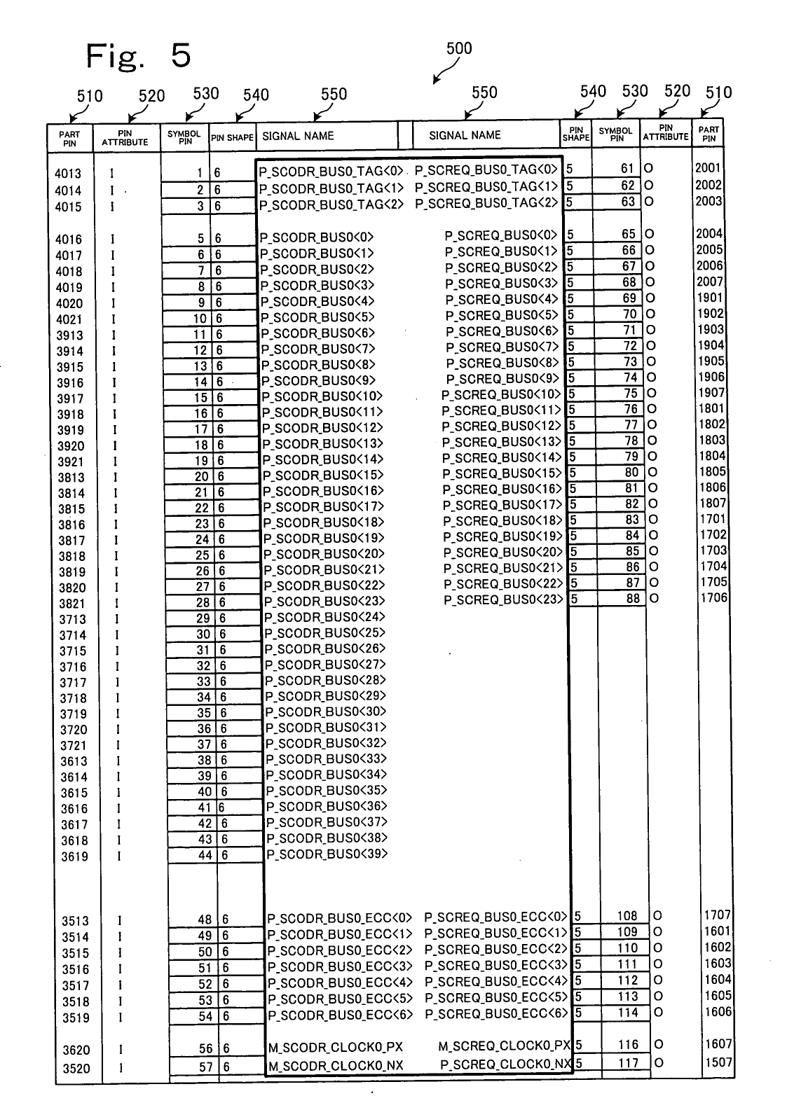

FIG. 5 is a table showing the configuration of a list representing the symbol data.

This list 500 has a part pin column 510, a pin attribute column 520, a symbol pin column 530, a pin shape column 540 and a signal name column 550, which are bilaterally provided in two sets. These two sets of columns correspond to the left and right of the symbol, and each stage in these columns corresponds to one pin. On the list 500, the ruled lines are drawn, corresponding to the outer shape of symbol and the leader line for visual understanding, though the rules lines are unnecessary for the CAD apparatus.

The part pin column 510 has the pin number given to each pin of an actual electronic part.

The pin attribute column 520 has the character representing the input/output form of pin, which is any one of character “I” representing the input pin, character “O” representing the output pin, “IO” representing the input/output pin, character “P” representing the power pin, character “G” representing the earth pin, and character “U” representing the undefined.

The symbol pin column 530 has the number given to each pin on the symbol.

The pin shape column 540 has the numerical value representing the shape of each pin on the symbol, which is any one of numerical value “1” representing the shape of normal pin, numerical value “2” representing the shape of output inversion pin, numerical value “3” representing the shape of input inversion pin, numerical value “4” representing the shape of logic inversion pin, numerical value “5” representing the shape of output pin, numerical value “6” representing the shape of input pin, numerical value “7” representing the shape of bi-directional pin, numerical value “8” representing the shape of bi-directional output pin, numerical value “9” representing the shape of bi-directional input pin, numerical value “10” representing the shape of analog pin, and numerical value “11” representing the shape of non-logical pin.

The signal name column 550 has the name representing the signal input or output into or from each pin.

In these columns, there are some stages of blank columns. For example, the stages between the symbol pin numbers 88 and 108 are blank columns. Such a blank column indicates that there is no pin on the symbol and a clearance is provided.

The attributes of pin as used in this invention include not only those described in the pin attribute column 520, but also those described in the part pin column 510, the pin attribute column 520, the symbol pin column 530, the pin shape column 540, and the signal name column 550.

The list as shown herein is easily created employing an edit function of the spread sheet software, even though there are a great number of stages.

The symbol data represented by the list 500 is read by the symbol data reading module 410 as shown in FIG. 4, and its symbol data is passed to the symbol creation module 430 to create the symbol.

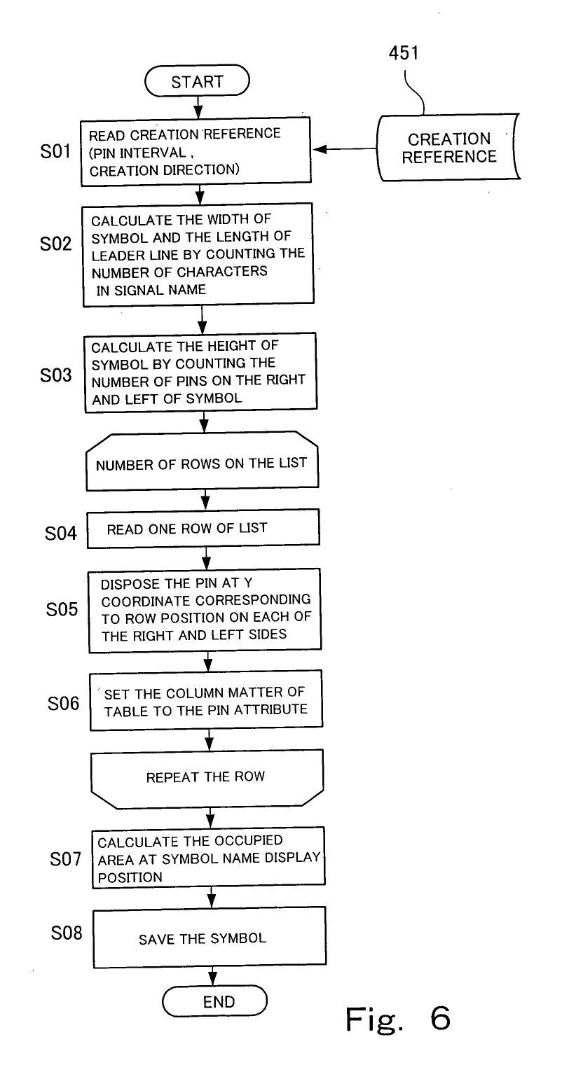

FIG. 6 is a flowchart showing a procedure of the symbol creation module 430 to create the symbol based on the symbol data. The procedure will be described below with reference to this flowchart and FIG. 5 as needed.

The procedure as shown in this flowchart is started when the symbol creation module receives the symbol data. First of all, the creation reference 451 is read from the creation reference storage section 450 shown in FIG. 4 (step S01). This creation reference 451 includes the symbol name, basic size of symbol, and pin arrangement interval, as well as the format of the list represented by the symbol data.

If the creation reference 451 is read, the number of characters for the name described in the signal name column 550 of the list 500 is counted, and the width of symbol capable of describing the name is calculated (step S02). Moreover, the number of stages including the blank column is counted for two left and right sets of columns in the list 500, and the height of symbol is calculated according to the greater number of stages (step S03).

Thereafter, the steps S04 to S06 are repeated by the number of rows (stages) in the list 500.

One row (stage) of the list 500 is firstly read (step S04). Then, when the attribute is described in that row, the pin is disposed at a position of Y coordinate on the symbol corresponding to the position of the described row. Since two pins are bilaterally described in one row of the list 500, confirmation is carried as to whether or not the attribute is described and the pin arrangement are performed for each of the left and right of the symbol (step S05). And the attribute described in that row is set as the attribute of the pin (step S06). When drawing the symbol, the attribute set in this way is represented on the drawing. In this embodiment, the pin number and the signal name among the attributes are represented in characters, and the input/output form of the pin is represented in the shape of figure representing the pin.

Thereafter, the above process is repeated by returning to step S04, until there is no row of the list 500.

If the process from step S04 to step S06 is repeated for all the rows of the list 500, the write position of symbol name and the area occupied by the symbol to exclude the drawing of wiring are calculated (step S07), whereby the shape of symbol is completed.

Finally, the symbol created in this way is stored in the symbol storage section 460 as shown in FIG. 4 (step S08).

In this way, with the CAD apparatus as described as the embodiment, the symbol is automatically created according to the attribute defined in the list, whereby it is unnecessary that the pin selection and the attribute input are repeated for each pin, resulting in the higher work efficiency.

When the apparatus of this embodiment is actually applied to the plotting operation, there is great effect that the work time is reduced at a reduction ratio of about 80%.

Though in the above explanation, the symbol creation device and the symbol creation program storage medium according to one embodiment of the invention are incorporated into the CAD apparatus and the CAD program storage medium, the symbol creation device and the symbol creation program storage medium of the invention may be independent from the CAD apparatus and the CAD program storage medium.

Though in the above explanation, the CAD apparatus comprises the pin data input module that receives the attribute input for each pin in the same way as conventionally, the CAD apparatus and the symbol creation device of the invention do not necessarily have the pin data input section.

Also, though in the above explanation, the list is created in advance employing the spread sheet software, the CAD apparatus and the symbol creation device of the invention may have a list creation function. When the list creation function is provided, the table data acquirement section of the invention acquires the list internally.

Also, though in the above embodiment, the CAD program and symbol creation program storage medium of the invention is the CD-ROM, for example, the symbol creation program and symbol creation program storage medium of the invention may be any kind of storage medium, as far as it can store the program. For example, it may be the magnetic disk of the hard disk device, flexible disk, MO disk, or DVD, or the card-type or tape-type storage medium.

What is claimed is:

1. A CAD apparatus having a plotting function of creating a drawing by arranging a part symbol at a position according to an operation, and a symbol creation function of creating the part symbol, comprising:
a table data acquirement section that acquires table data representing a list describing the attributes of each pin of an electronic part having plural pins; and
a symbol pin arrangement section that applies each symbol pin, which has the same attribute as each attribute described in the list represented by the table data acquired by the table data acquirement section, to a part symbol representing the electronic part in an arrangement corresponding to a described position of the attribute in the list.

2. The CAD apparatus according to claim 1, wherein the symbol pin arrangement section treats a blank column in the list as a position where the symbol pin does not exist.

3. A symbol creation device that creates a part symbol to be used with a CAD apparatus that creates a drawing by arranging a part symbol at a position according to an operation, comprising:
a table data acquirement section that acquires table data representing a list describing the attributes of each pin of an electronic part having plural pins; and
a symbol pin arrangement section that applies each symbol pin, which has the same attribute as each attribute described in the list represented by the table data acquired by the table data acquirement section, to a part symbol representing the electronic part in an arrangement corresponding to a described position of the attribute in the list.

4. A CAD program storage medium storing a CAD program incorporated into a computer to enable the computer to operate as a CAD apparatus having a plotting function of creating a drawing by arranging a part symbol at a position according to an operation, and a symbol creation function of creating the part symbol, the program constructing on the computer comprising:
a table data acquirement section that acquires table data representing a list describing the attributes of each pin of an electronic part having plural pins; and
a symbol pin arrangement section that applies each symbol pin, which has the same attribute as each attribute described in the list represented by the table data acquired by the table data acquirement section, to a part symbol representing the electronic part in an arrangement corresponding to a described position of the attribute in the list.

5. A symbol creation program storage medium storing a symbol creation program incorporated into a computer to enable the computer to operate as a symbol creation device that creates a part symbol to be used with a CAD apparatus that creates a drawing by arranging the part symbol at a position according to an operation, the program constructing on the computer comprising:
a table data acquirement section that acquires table data representing a list describing the attributes of each pin of an electronic part having plural pins; and
a symbol pin arrangement section that applies each symbol pin, which has the same attribute as each attribute described in the list represented by the table data acquired by the table data acquirement section, to a part symbol representing the electronic part in an arrangement corresponding to a described position of the attribute in the list.
